(19) United States
(12) Patent Application Publication
(10) Pub. No.: US 2015/0332229 A1
(43) Pub. Date: Nov. 19, 2015

(54) Prepaid Check System

(71) Applicant: William Rowan, Huntsville, AL (US)

(72) Inventor: William Rowan, Huntsville, AL (US)

(21) Appl. No.: 14/714,294

(22) Filed: May 17, 2015

Related U.S. Application Data
(60) Provisional application No. 61/994,883, filed on May 17, 2014.

(51) Int. Cl. G06Q 20/10; G06Q 20/16

(52) U.S. Cl. CPC G06Q 20/102; G06Q 20/16

(57) ABSTRACT

The disclosed system integrates an electronic payment system with the ability to generate, accept, and/or track paper checks as well as electronic payments. One embodiment of the system includes software enabled to open an electronic account and accept funds into that account. Then, the user of that account may select either to generate an electronic payment, or alternatively, to print off a paper check from that account, using the account number of the electronic account and the name of the recipient for whom the check was intended.

### CROSS-REFERENCE TO RELATED APPLICATIONS

This application claims priority benefit of U.S. Provisional Patent Application No. 61/994,883, entitled “P2P/Marketplace Module,” filed May 17, 2014. The disclosures in those applications are incorporated herein in their entirety.

### BACKGROUND AND SUMMARY

The present invention relates generally to electronic payment systems, and more particularly to payment systems that enable electronic payment transfers along with physical payment checks, and which allow an image of the check to be transferred and/or printed.

Currently, there exist electronic payment systems that allow users to send or receive electronic payments quickly through computers or mobile electronic devices. On the other hand, traditional banks continue to provide paper checks that continue to require paper checks to be procured prior to making payment, and customers are unable to make payments until new paper checks are ordered. However, there is not currently a system that connects these two systems, allowing the user to provide relatively quick electronic payments or relatively quick paper check generation.

The present system may solve these problems and others by integrating an electronic payment system with the ability to generate, accept, and/or track paper checks as well as electronic payments.

As a non-limiting example, one embodiment of the system may include software enabled to open an electronic account and accept funds into that account. Then, the user of that account may select either to generate an electronic payment, or alternatively, to print off a paper check from that account, using the account number of the electronic account and the name of the recipient for whom the check was intended.

### BRIEF DESCRIPTION OF THE FIGURES

FIG. 1 shows a user interface of an embodiment of the system.

FIG. 2 shows a flowchart of the operation of an embodiment of the system.

FIG. 3 shows a flowchart of the check scanning module of the system.

### DETAILED DESCRIPTION

While the exemplary embodiments illustrated herein may show various features, it will be understood that the different features disclosed herein can be combined variously to achieve the objectives of the present invention.

The overall concept of the present invention is to provide a system to allow users to create and fund an online financial account. The user may then have a choice to send and receive money electronically, or to optionally generate paper checks from the account using a printer. In various embodiments, the user may have options to use their own bank account number on the check, use a prepaid account number, or generate their own account number for use on the check. The latter may be similar to unique numbers used on certified checks or money orders.

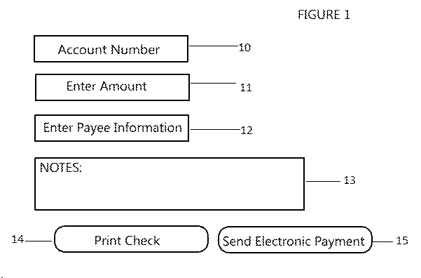

Turning to FIG. 1, this figure shows one embodiment of a user interface of the disclosed system in which a user creates an online account. At the creation step, an account number 10 is attached to the account. This number may be a standard ABA routing and account number used by most banks, or it could be a proprietary account number format. In the proprietary single number format, the issuer of the check may use a single number that has routing number and account number it it—which may uniquely identify the issuer. Next, the account may be funded by the user, which may be done by a variety of methods. Alternatively, the user may accept a payment. Then, the user may send a payment—choosing to make an electronic payment 15 to another account. Alternatively, the user may select to create a paper check. If the user chooses this option, the system takes the relevant information—payment amount 11 and recipient 12—and creates a pre-printed, filled-out check at a printer. The user may then send that check to the recipient.

In this embodiment, the user of the online payment system may create a paper check 14 with the account number on it, such as the proprietary account number or ABA routing and account information. In an alternative embodiment, the check may have a proprietary account number, such that it can only be redeemed by the recipient at an account of the same organization of the issuer, or the organization running the disclosed system. In yet another embodiment, the check may have a code that can be scanned to be redeemed, such as a bar code, QR code, OCR-capable digits, or other type of machine-readable code. Further, the printed check may include an indicator of the issuer of the check, or company that operates the system—which may be in the account number itself.

In yet another embodiment, the online payment system may also be integrated with a proprietary currency, online currency, or cryptocurrency, such as Bitcoin. In this embodiment, the proprietary currency may be the currency used in system's paper checks and electronic payments. Therefore, a user of the system can deposit money into the online currency, create checks denominated in the online currency, and send electronic payments in that online currency. As a non-limiting example, the funds may be stored with a 17 digit number (for example) to identify the currency and its owner, and this number may be used as an “account” number 10 on the printed checks or in an electronic payment made in that currency.

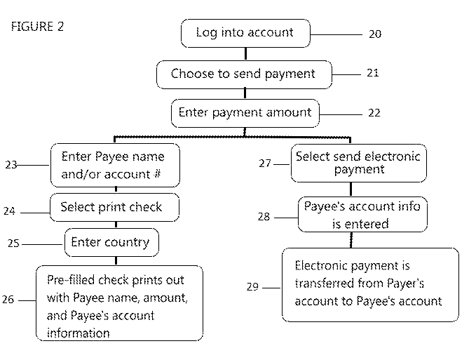

As FIG. 2 shows, a user may log into the software or system with a login or account number 20. Once logged in, the user can choose a software module to send a payment 21. In this module, the user may input the recipient identification 23 (name, identification pseudonym, account number, or similar) and payment amount 22. The pseudonym may enable a user of the system to remain anonymous—creating checks and sending money by simply funding the account without the requirement of a bank account or personal information. Then, the user can push a button to send the payment electronically to the recipient 27, or alternatively, push a button to begin a subroutine to print a paper copy of the filled-out check 24. Here, there can also be a module 25 for selecting the country which the check intends to be used in. Therefore, the system can include an account number in the banking format required by that country. Or, the check may include several account number formats for possible use in several countries. Alternatively, the account number may be a single unified account number that can work in any country, at an account of the issuer, regardless of country. The system may work with an account residing at the operator of the software, or the system can be configured to send a payment or print a check from an existing third-party checking account.

In other optional features of this system, the system may track outstanding check payments that have been made and not yet redeemed in the account. It may then track when the payment has been redeemed. In yet another feature, the system may be linked directly to another existing bank account. Or, the system may act as a standalone account, such that no bank account is required to generate payments. In this embodiment, it allows a user to generate checks without having to open a standard bank account. In this embodiment, a user can fund an online account and generate checks from it without having to join or belong to a bank. Therefore, the system may have the desirable outcome of allowing a user to send electronic payments and/or paper check payments using an account created and funded wholly through an online provider who uses the disclosed system. There may also be a variety of funding options, such as funding with a credit card, an electronic cash transfer, with a transfer from another user of the same system, or sending cash or check to the operator of the system. Additionally, a paper check could be created from a check card or from a prepaid payment card purchased from a store, for example. These differently configured systems may eliminate the need to take cash into a traditional bank to open a checking account.

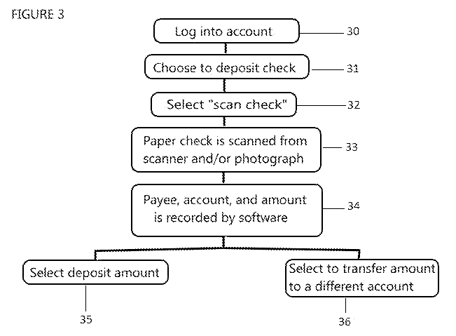

Turning to FIG. 3, this figure shows an embodiment of the system that allows the scanning of paper checks. In this embodiment, the user notifies the system to scan a paper check 32. The system then optically scans the check 33. This can be either using an optical scanner with OCR, using a laser barcode scanner, by taking a picture of the check, or other optical scanning method. Then, the system records the amount of the check, and the account the debit the amount to 34. The system then processes this payment to retrieve the amount from the account sending the payment. Then, the system may add this amount to the balance of the user's account 35. In one embodiment, this may be processed from the check and account of any bank or ABA bank account. Or alternatively, this could be solely from account number of other users of the same system and operator of the disclosed system, such that users of the systems can send checks to each other 36. Therefore, once the check is scanned, the system may immediately provide the user with the option of either depositing the check amount into his account, or alternatively to immediately issue the full amount of the check as an electronic transfer to the account of a third party.

In an alternate embodiment, the user could direct the system to scan the paper check directly to the generation of an electronic payment. This electronic payment may then be made to the user himself, to another user of the system, or to a remote account. As an additional feature, this system could be locally installed on the user's computer or could be resident on the cloud. Alternatively, the system could be used with a mobile electronic device or with an electronic payment application (“app”). Any of these devices could be coupled to a local or remote printer and/or scanner for the generation or acceptance of checks. In addition, this system could be couples with a Point of Service (POS) payment system, in which payment is directed from the online software to a POS payment system. In this embodiment, a POS system could be enabled to receive an electronic payment directly from the an electronic transfer from the disclosed system. Such a system could rely on a digital signature from the payment system to transfer electronic payment to the POS system from an electronic device or smart device running the disclosed software. Alternatively, the POS system could be enabled to receive or scan a paper payment from the disclosed system using unique coding or account numbers.

In another embodiment of the present invention, the check-printing aspect of the invention may be used as an add-on application for an existing online payment account or to an existing bank account. This could allow a person to print and issue pre-filled checks without having to pay and wait for pre-printed checks. It may also allow the user to print checks without having to write in the recipient's name and payment amount.

In another feature of the present invention, the software may allow the user to create an automated checkbook or ledger of outgoing checks, whether they have been cashed or not, who the recipients were, as well as incoming scanned checks. This feature may be coupled to an online payment system or an existing bank account.

Another version of the disclosed system may be adapted to international check types, as in 25. Different countries have different check codes and account number formats. In this version, the user may first select the country for which he wishes to print a check. The system then adapts the check to the country format then prints the check. It may also update the currency automatically. Another version of the system may also automatically detect the country from the format of a scanned check and adapt accordingly to process the check and/or change the currency involved.

Another optional aspect of this system can be integration of the online system with a user card. This card can be a debit card, which debits against funds in the online account. Alternatively, the card can be a check card coupled to the online checking account, such that the account can be debited electronically in physical locations, such as stores. Or, this function can be performed using another method known in the art, such as electronic communication of funds, using the wireless communication from a smartphone or similar device. As one example, an NFC chip (ACH type of tokenization, as one example) can be used in a smartphone to communicate the transfer of funds from the online checking account at a physical store. This can also be done using any similar secure wireless transmission method that arises in the art, as non-limiting examples, Apple Pay, FI Billpay, or any future developed payment system. The intention is to effect an electronic transfer of funds to the store, along with a corresponding deduction from the online checking account, using a secure communication method.

Any combination of the above features and options could be combined into a wide variety of embodiments. It is, therefore, apparent that there is provided in accordance with the present disclosure, systems and methods for designing and implementing electronic payment systems that combine both electronic payments with the ability to generate and accept paper checks, while verifying and validating funds availability. While this invention has been described in conjunction with a number of embodiments, it is evident that many alternatives, modifications, and variations would be, or are apparent to, those of ordinary skill in the applicable arts. Accordingly, applicants intend to embrace all such alternatives, modifications, equivalents and variations that are within the spirit and scope of this invention.

What is claimed is:

1. A system for managing a check creation account, said system comprising:
a module for accepting the registration information from a user;
a module for creating an account for the user based on said registration information;
a module for accepting payment from the user;
an electronic payment module, comprising:
a module for accepting instruction from said user to specify the recipient and amount of an electronic payment,
a module for sending the electronic payment to the account of said recipient, and
a module for debiting said account of said user in the amount specified for the electronic payment; and
a check printing module, comprising:
a module for accepting instruction from said user to specify the recipient and amount of said check,
a module for sending the image of the said check with said recipient and said amount to a printer, and
a module for debiting said account of said user in the amount specified for said check.

2. The system of claim 1, wherein said image of said check further includes an indicator of the issuer of the check.

3. The system of claim 2, wherein said indicator further includes an account number that can only be redeemed by said recipient at the issuer of the check.

4. The system of claim 2, wherein said indicator is a single number that contains both routing and account information.

5. The system of claim 2, wherein said indicator further includes a bar code that can only be redeemed by said recipient at the issuer of the check.

6. The system of claim 2, wherein said indicator further includes a QR code that can only be redeemed by said recipient at the issuer of the check.

7. The system of claim 1, wherein said registration information includes a pseudonym selected by said user and said pseudonym is included on said check.

8. The system of claim 1, wherein said payment from said user is deposited via one of: a credit card or a debit card.

9. The system of claim 1, wherein said payment from said user is deposited via an electronic transfer from another account.

10. The system of claim 1, further comprising a module for creating a check card for said user, the module comprising:
a module for creating a check card that is associated with the account of the user of said check card, and
a module for debiting said account of said user when said user presents the check card for use in a purchase.

11. The system of claim 1, further comprising a module for creating a smartphone electronic payment system for said user, the module comprising:
a module for installation on a smartphone that associates the smartphone with the account of the user of said check card, and
a module for debiting said account of said user when said user presents the smartphone for use in a purchase and indicates that a payment is intended to be sent from the smartphone.

12. The system of claim 1, further including a module for selecting the country of usage for the printed check, wherein said module includes an account number in the format required by banking systems in that country on the check image to be printed.

13. The system of claim 1, further comprising a check scanning module, said check scanning module comprising:
a module for accepting the scanned image of a check,
a module for analyzing said image of said check to determine the issuer of said check and the amount of the check, and
a module for adding said amount of said check to the account of said user.

14. The system of claim 13, wherein said scanned image is accepted from the photograph of said check.

15. The system of claim 13, wherein said scanned image is accepted from a scanned code of said check.

16. The system of claim 1, further comprising a check scanning module, said check scanning module comprising:
a module for accepting the scanned image of a check,
a module for analyzing said image of said check to determine the issuer of said check and the amount of the check, and
a module for immediately giving said user the option to send said amount to a recipient as an electronic transfer.

17. The system of claim 16, wherein said scanned image is accepted from the photograph of said check.

18. The system of claim 16, wherein said scanned image is accepted from a scanned code of said check.

19. The system of claim 3, further comprising a check scanning module, said check scanning module comprising:
a module for accepting the scanned image of a check,
a module for analyzing said image of said check to determine the issuer of said check and the amount of the check, and
a module for adding said amount of said check to the account of said user.

20. The system of claim 3, further comprising a check scanning module, said check scanning module comprising:
a module for accepting the scanned image of a check,
a module for analyzing said image of said check to determine the issuer of said check and the amount of the check, and
a module for immediately giving said user the option to send said amount to a recipient as an electronic transfer.
